(19) United States
(12) Patent Application Publication
(10) Pub. No.: US 2024/0309669 A1
(43) Pub. Date: Sep. 19, 2024

(54) FLOOD BARRIER APPARATUS

(71) Applicant: Jason Robert Fries, Marco Island, FL (US)

(72) Inventor: Jason Robert Fries, Marco Island, FL (US)

(21) Appl. No.: 18/606,480

(22) Filed: Mar. 15, 2024

Related U.S. Application Data
(60) Provisional application No. 63/490,537, filed on Mar. 16, 2023.

(51) Int. Cl. E04H 9/14

(52) U.S. Cl. CPC E04H 9/145

(57) ABSTRACT

A flood barrier apparatus to protect structures from low level flooding. A barrier panel is releasably secured to U-shaped channels positioned on each side of an opening, such as an entry door or patio door. A separate gasket is secured to the bottom of the barrier panel. The U-shaped channels include gaskets on each side of the channel; the gaskets seal the barrier panel against low level flooding. Lock pins secure the barrier panel in position during use.

### PRIORITY CLAIM

In accordance with 37 C. F. R. § 1.76, a claim of priority is included in an Application Data Sheet filed concurrently herewith. Accordingly, the present invention claims priority to U.S. Provisional Patent Application No. 63/490,537, entitled “FLOOD BARRIER APPARATUS”, filed Mar. 16, 2023, the contents of which are incorporated hereby by reference.

### FIELD OF THE INVENTION

The present invention relates to flood protection for structures; and, in particular, to a low cost flood barrier that can protect a structure from low level flooding.

### BACKGROUND OF THE INVENTION

Individuals choose to live near water for numerous reasons. The actual reason may be personal to the individual, but most everyone will agree that being near water is known to improve one's health, body and mind. For whatever reason, living on a water front property is extremely desirable, as reflected by the property values which tend to be higher for properties on, or close to, the water. Waterfront properties on ponds, lakes, rivers, canals for fresh or salt water have always come at a premium price. Properties adjacent to the waterfront properties may still extract a high value, as the residents may easily use or visit the adjoining water.

However, living near waterfront can also be problematic. Living in a coastal community makes low level properties susceptible to tidal or storm surges. For instance, a king tide is an especially high tide that occurs when the gravitational forces of the sun, moon, and Earth align. These tides happen twice a year, during the new moon and full moon, when the sun and moon's gravitational pulls are in sync and reinforce each other. King tides are not a result of climate change, but they can be made worse by sea-level rise. As sea levels continue to rise due to global warming, king tides can cause more frequent and severe flooding in low-lying areas. High winds, such as a hurricane, can cause the sea level to rise in what is known as a storm surge. A storm surge is an abnormal rise in sea level that occurs when strong winds push water toward the shore. The combination of low atmospheric pressure and high winds can cause the water level to rise by several feet, which can then flood coastal areas. Even if the water level in a home is only few inches deep, water causes extensive damage to infrastructure and homes.

Other waterfront areas can also be damaged by water entering structures. For instance, a river can overflow its banks and cause flooding due to heavy rainfall. For instance, when there is a lot of rainfall in a short period of time, the amount of water in the river can quickly increase, causing it to rise and potentially overflow its banks; or when debris, such as fallen trees or trash, accumulates in a river, it can cause the flow of water to slow down or even stop, leading to flooding. As snow and ice melt, the water flows into the river and can cause it to rise and overflow. When trees and other vegetation are removed from the surrounding area, the land becomes less able to absorb water, increasing the likelihood of flooding. As cities and towns grow, more and more impervious surfaces like pavement and buildings are created. This reduces the amount of land that can absorb water, which can lead to increased runoff and flooding. In summary, the rise of a body of water can occur as a result of many environmental issues and is difficult to predict. However, residents that build in flood zones should recognize the risks and take appropriate actions to help deter a water damage instance.

The problem, to which this invention addresses, is the low level flooding that is just enough to enter a structure. The temporary placement of flood barrier panels in front of structure openings helps deter the damage caused by even a few inches of water from entering the structure. Even a few inches of water can destroy flooring and drywalls. What is needed in the industry is a low cost flood barrier apparatus that can be easily installed to protect a structure from otherwise low level flooding.

### SUMMARY OF THE INVENTION

Disclosed is a temporary flood barrier apparatus to protect structures from low level flooding. The flood barrier is installed when a possible low level flooding may occur, such as that less than three feet. A barrier panel is releasably secured to U-shaped channels positioned on each side of an opening, such as an entry door or patio door. A separate gasket is secured to the bottom of the barrier panel. The U-shaped channels include gaskets on each side of the channel; the gaskets seal the barrier panel against low level flooding. Water pressure during a flooding event pushes the barrier panel into the gasket to help in water sealing. Lock pins secure the barrier panel in position during use.

An objective of the instant invention is to provide a temporary flood barrier for structure openings that are at ground level, namely entry doors and patio doors.

Another objective of the invention is to provide a low cost flood barrier to protect a structure from flooding less than 4 feet.

Still another objective of the invention is to provide a flood barrier that is easily installed and disassembled.

Other objectives and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE DRAWINGS

FIG. 1 is an environmental figure of a structure with door openings;

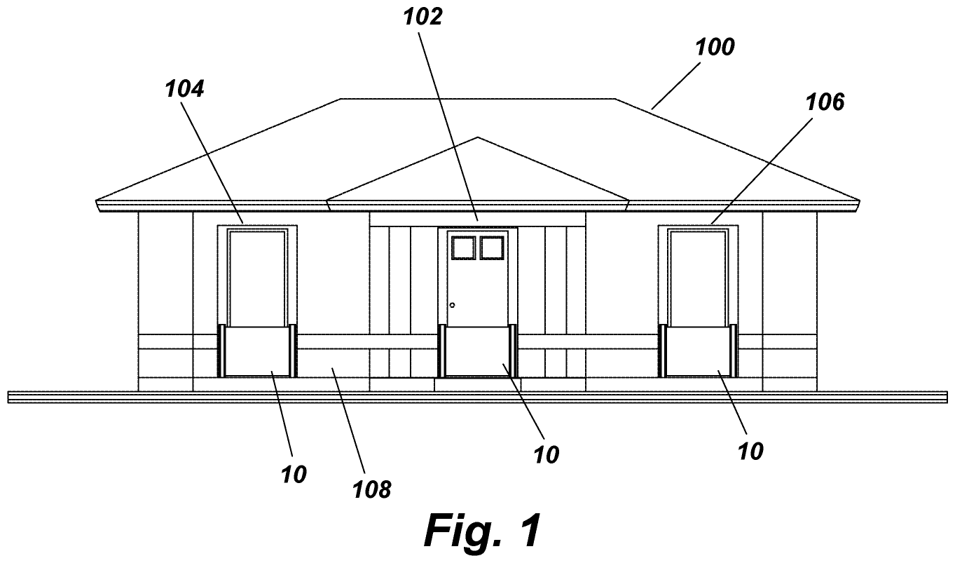

FIG. 2 is front plane view of flood barrier apparatus;

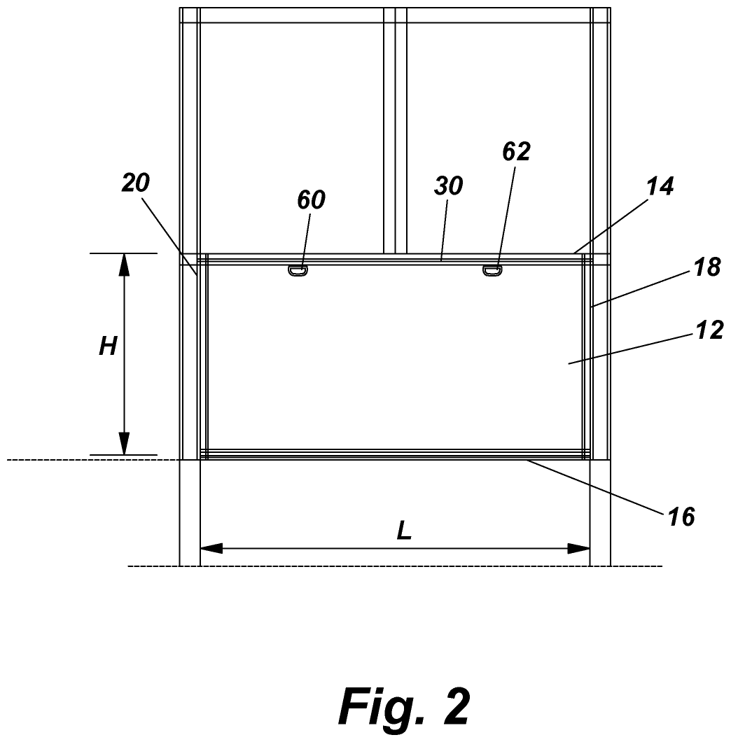

FIG. 3 is an exploded side view;

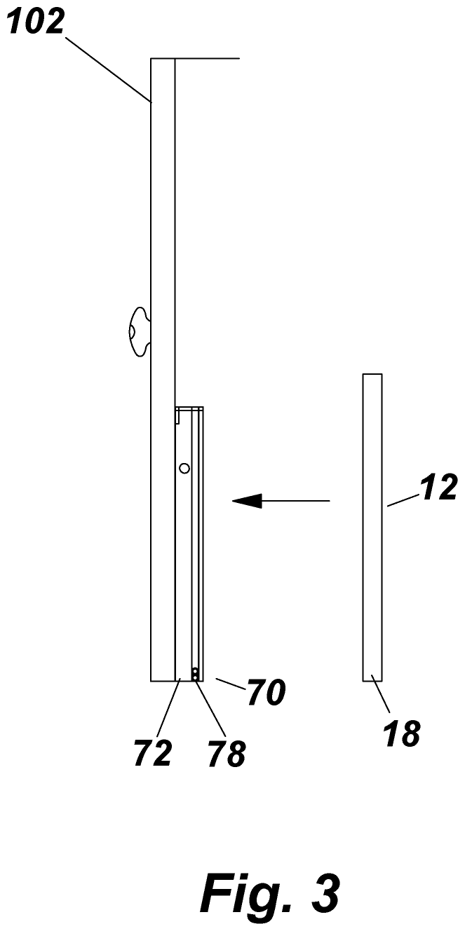

FIG. 4 is an enlarged top view of the U-shaped channel;

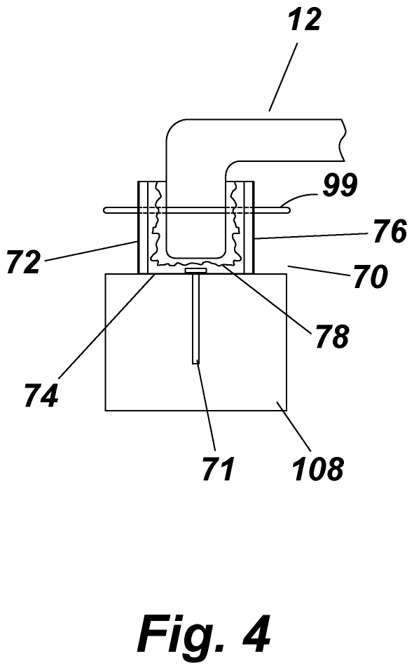

FIG. 5 is an enlarged top view of the flood barrier panel secured to the U-shaped channel; and

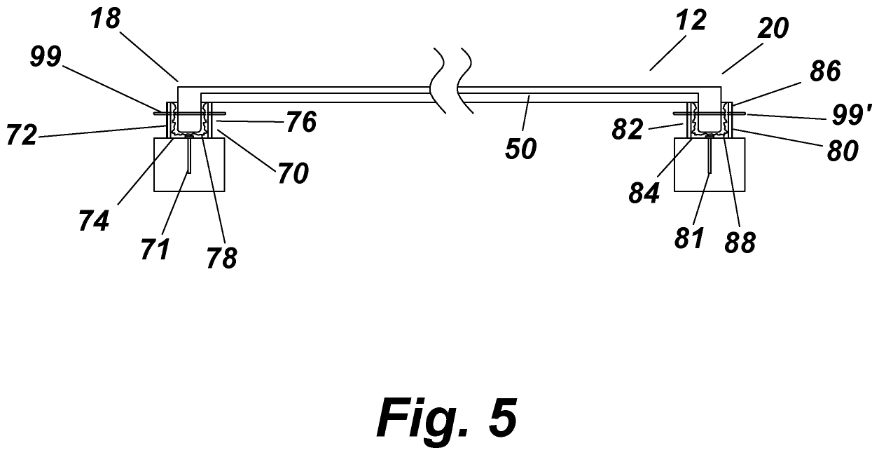

FIG. 6 is a perspective view of the flood barrier panel.

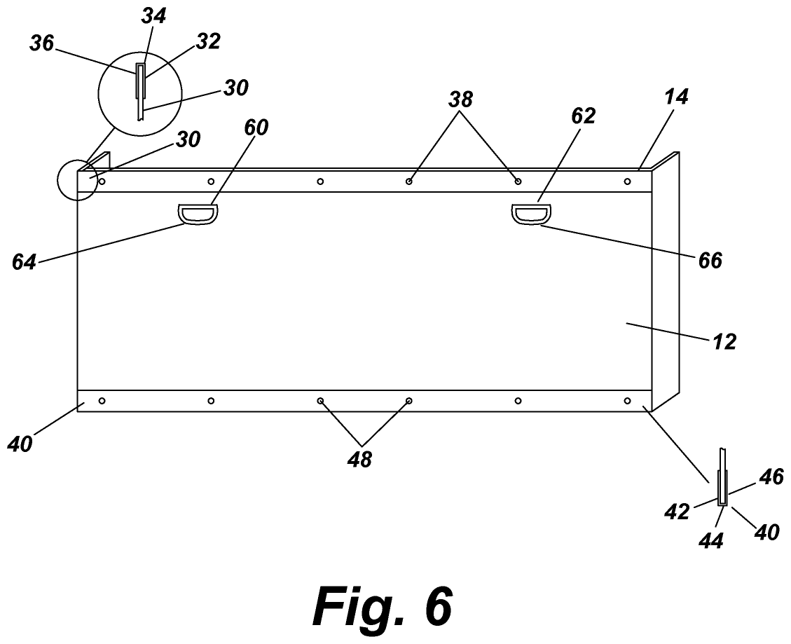

### DETAILED DESCRIPTION OF THE PREFERRED EMBODIMENT

Detailed embodiments of the instant invention are disclosed herein; however, it is to be understood that the disclosed embodiments are merely exemplary of the invention, which may be embodied in various forms. Therefore, specific functional and structural details disclosed herein are not to be interpreted as limiting, but merely as a basis for the claims and as a representation basis for teaching one skilled in the art to variously employ the present invention in virtually any appropriately detailed structure.

Referring now to the drawings, illustrated is the flood barrier apparatus 10 of the instant invention. The flood barrier is for use with a conventional structure 100.

Illustrated is a home having a front door opening 102 and sliding doors 104, 106, namely entry doors and patio doors. The flood barrier apparatus is formed from a rigid aluminum panel 12 defined by an upper edge 14 spaced apart from a lower edge 16 forming a panel height H, and a first insert end 18 spaced apart from a second insert end 20 forming a panel length L. The first insert end and the second insert end are formed perpendicular to the panel upper 14 and lower edge 16. In one embodiment the aluminum panel is 0.068 inch gauge corrugated aluminum, which is suitable for openings spanning about 8 foot. Thicker panels may be used to cover wider openings. Other materials may also be used, such as steel, fiberglass, basalt or plastic. For instance, acrylic panels may be used, wherein the clear material does not detract from the structure appearance when the panels remain installed. Aluminum is a preferred material due to its rigidity, light weight, ease of formation, and low cost.

In the preferred embodiment, the upper edge of the panel is reinforced with a ⅛ inch thick U-shaped rail 30, preferably aluminum, to provide a thickness along the edge of the panel which provides reinforcement from bending; the rail 30 having a first side wall 32, adjoining wall 34, and a second side wall 36. The height of the panel is less than 48 inches, which allows an individual to enter or exit the structure once the panels are installed. The rail 30 further removes the otherwise sharp edge that can otherwise result in injury if someone steps over the panel once installed. The rail 30 is secured to the panel using rivets 38, preferably ⅛ inch stainless steel rivets positioned approximately 8 inches on center.

Similarly, the lower edge 16 of the panel 12 is reinforced with a ⅛ inch thick U-shaped rail 40 to provide a thickness along the edge of the panel which provides reinforcement from bending; the rail 40 having a first side wall 42, adjoining wall 44, and a second side wall 46. The rail 40 further removes the otherwise sharp edge that can otherwise result in injury if someone picks up the panel or drops the panel during removal or installation. The rail 40 is secured to the panel 12 using rivets 48, preferably ⅛ inch stainless steel rivets positioned approximately 8 inches on center.

A ½ inch diameter rubber gasket 50 is secured to the bottom rail 40, providing a water seal between the panel 12 and the structure frame located at the bottom of the door opening. Apertures 60, 62 are positioned beneath the upper edge 14 of the barrier panel 12. The apertures 60, 62 are about 2 inches×4 inches and are used as a hand hold for moving of the barrier panel 12. The edge of the opening may include a plastic edge sleeve 64 and 66 to provide a hand hold without a sharp edge.

A first U-shaped channel 70 and second U-shaped channel 80 is attached to each side of the door opening. The U-shaped channels are interchangeable and consist of a first side wall 72, 82, a back wall 74, 84, and a second side wall 76, 86. In addition, the inner surfaces of the first and second channel 70, 80 includes a gasket 78, 88 constructed and arranged to receive the first 18 and second insert end 20, forming a water tight seal. In one embodiment, the channel gasket 78, 88 is a ¼ inch diameter gasket positioned on each side of the channel to seal the barrier panel insert edges positioned between the gaskets. The gasket is made of a flexible material, such as rubber or silicone, and is sized to fit within the U-shaped channel to provide a watertight seal with the panel insert ends. The first U-shaped 70 channel is attached to the left side of the opening, and the second U-shaped channel 80 is attached to the right side of the opening, by fasteners 71, 81; the fasteners passing through the bottom wall and secured to the masonry or wood framed structure opening 108. Once the panel is in position, the first and second insert ends provide a water-tight seal on each side of the structure opening by engaging the gasketed U-shaped channels; and the gasket on the lower edge provides a water-tight seal on the bottom of the structure opening. To maintain the panel in a sealed position, at least one lock pin 99 is placed through the first 72 and second side wall 76 of the first U-shaped channel 70, passing through the panel insert end 18, and at least one lock pin 99′ is placed through the first and second side wall of the second U-shaped channel, also passing through the panel insert end. The lock pins are configured to extend through a U-shaped panel and the insert edge of the barrier panel to prevent dislodging during flood conditions. It is noted that under flood conditions, water pressure against the barrier panel helps to seal the barrier panel against the gasket.

Installation requires the U-shaped channel to be secured to each side of the structure opening; the channel having a gasket on the inner side wall of the channel. Should the possibility of a water level rise be expected, a barrier panel is operatively associated with the channels having insertion ends that are placed within the channel, the gasket sealing against the insert edges. The bottom of the barrier panel includes a gasket, wherein the sides and bottom operate to stop water from entering the structure. The barrier panel is pinned to the channels by the use of lock pins. The result is an inexpensive flood barrier that is easily installed/removed and gives the structure a few more feet of protection in the case of a flooding condition.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs.

The term “coupled” is defined as connected, although not necessarily directly, and not necessarily mechanically. The use of the word “a” or “an” when used in conjunction with the term “comprising” in the claims and/or the specification may mean “one,” but it is also consistent with the meaning of “one or more” or “at least one.” The term “about” means, in general, the stated value plus or minus 5%. The use of the term “or” in the claims is used to mean “and/or” unless explicitly indicated to refer to alternatives only or the alternative are mutually exclusive, although the disclosure supports a definition that refers to only alternatives and “and/or.”

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

1. A flood barrier apparatus for a door opening comprising:
a barrier panel having an upper edge spaced apart from a lower edge forming a panel height, and first insert end spaced apart from a second insert end forming a panel length, said first insert end and said second insert end formed perpendicular to said panel upper and lower edge, said panel constructed and arranged to cover a lower portion of a door opening;
a first U-shaped channel attached to one side of the door opening, said first U-shaped channel including a gasket located in said channel;
a second U-shaped channel attached to an opposite side of the door opening, said second U-shaped channel including a gasket located in said channel; and
a gasket attached to said lower edge of said barrier panel;
wherein said barrier panel first and second insert ends are slidably inserted into the U-shaped channels, wherein said gaskets provide a water-tight seal between said barrier panel and a structure.

2. The flood barrier apparatus according to claim 1 wherein said barrier panel is constructed from corrugated 0.068 inch gauge aluminum.

3. The flood barrier apparatus of claim 1 wherein said gasket is made of a flexible material, such as rubber or silicone, and is sized to fit within said U-shaped channel to provide a water-tight seal with said barrier panel.

4. The flood barrier apparatus according to claim 2 including a ⅛ inch U-shaped rail secured to said upper edge with rivets.

5. The flood barrier apparatus according to claim 1 including at least one aperture positioned beneath said upper edge for use as a hand hold while handling the barrier panel.

6. The flood barrier apparatus according to claim 2 including a ⅛ inch U-shaped rail secured to said lower edge with rivets.

7. The flood barrier apparatus according to claim 5 including a rubber gasket extending from an edge of said lower edge U-shaped rail.

8. The flood barrier apparatus according to claim 1 including at least one aperture positioned beneath said upper edge for use as a hand hold while handling.

9. The flood barrier apparatus according to claim 1 including at least one lock pin configured to extend through a U-shaped panel and said panel to secure said barrier panel in said U-shaped channels to prevent dislodging during flood conditions.

10. The flood barrier apparatus according to claim 1 wherein said U-shaped channel gasket is further defined by a ¼ inch diameter gasket positioned on each side the channel, wherein said barrier panel edge is positioned between the gaskets.

11. A flood barrier apparatus for a door opening comprising:
a barrier panel having an upper edge spaced apart from a lower edge forming a panel height, and first insert end spaced apart from a second insert end forming a panel length, said first insert end and said second insert end formed perpendicular to said panel upper and lower edge, said panel constructed and arranged to cover a lower portion of a door opening;
a first U-shaped channel attached to one side of the door opening, said first U-shaped channel including a ¼ inch diameter gasket positioned on each side of the channel;
a second U-shaped channel attached to an opposite side of the door opening, said second U-shaped channel including a ¼ inch diameter gasket positioned on each side of the channel;
a gasket attached to said lower edge of said barrier panel;
at least one lock pin configured to extend through a U-shaped panel and said panel to secure said barrier panel in a U-shaped channel;
wherein said barrier panel first and second insert ends are slidably inserted into the U-shaped channels, wherein said gaskets provide a water-tight seal between the barrier panel and the structure.

12. The flood barrier apparatus according to claim 11 wherein said barrier panel is constructed from 0.068 inch gauge corrugated aluminum.

13. The flood barrier apparatus according to claim 11 including a ⅛ inch U-shaped rail secured to said upper edge with rivets positioned approximately 8 inches on center.

14. The flood barrier apparatus according to claim 11 including at least one aperture positioned beneath said upper edge for use as a hand hold while handling the barrier panel.

15. The flood barrier apparatus according to claim 11 including a ⅛ inch U-shaped rail secured to said lower edge with rivets positioned approximately 8 inches on center.

16. The flood barrier apparatus according to claim 15 including a rubber gasket extending from an edge of said lower edge U-shaped rail.

17. The flood barrier apparatus according to claim 1 including at least one aperture positioned beneath said upper edge for use as a hand hold while handling.
